(19) United States
(12) Patent Application Publication
(10) Pub. No.: US 2015/0199180 A1
(43) Pub. Date: Jul. 16, 2015

(54) METHOD AND SYSTEM OF EDITING WORKFLOW LOGIC AND SCREENS WITH A GUI TOOL

(71) Applicant: Clevest Solutions Inc., Richmond (CA)

(72) Inventors: Kenny Wai-doon Louie, Richmond (CA); Pui Wing Arthur Lo, Richmond (CA); Philip Wu, Richmond (CA); Chung Foo Wu, Richmond (CA); Patrick-Alain Joseph Numainville, Richmond (CA); Shuk Yee Wendy Lee, Richmond (CA)

(21) Appl. No.: 14/467,905

(22) Filed: Aug. 25, 2014

Related U.S. Application Data
(63) Continuation of application No. 12/196,069, filed on Aug. 21, 2008, now abandoned.

(51) Int. Cl. G06F 9/44

(52) U.S. Cl. CPC G06F 8/20; G06F 8/34

(57) ABSTRACT

A workflow management system provides a graphical user interface (GUI) tool that allows a user to create and/or edit workflow logic without requiring the re-writing and recompiling of the application software, and without interrupting the operability of the application software at any time. The GUI tool allows the user to simultaneously view and create and/or edit the corresponding application screen where the workflow logic is applied in the application software, while the user creates and/or edits the workflow logic. The user creates and/or edits the workflow logic by selectively combining the available parameters that are provided in spoken language syntax by a context sensitive menu. The workflow logic statements are made available for the application software to call at the appropriate times. The GUI tool works in conjunction with a dynamically configurable database.

### BACKGROUND OF THE INVENTION

1. Field of Invention

The present invention relates to workflow management systems and in particular to a system and method for creating and/or editing business workflow logic using a graphical user interface.

2. Background of the Invention

Many businesses use application software to manage and analyze workflows. Workflow software applications potentially increase productivity and efficiency by assisting and/or automating the control of business functions and processes, including work orders, logistics, inventory management, manufacturing, transaction approval and validation.

Each business entity implements its own unique business processes that are a function of its industry, organizational structure and unique business plan. As a result, companies typically develop customized software to meet the specific requirements of their business processes.

Many software applications cannot readily accommodate changes to a company's business plans and processes that require modifications to the application's workflow logic, or require adding and/or re-defining the data fields in the system. Modifications to the application's workflow logic also typically require modifications to the application's user screens or the addition of new user screens.

The updating of customized software applications to accommodate changes to the company's business plans and processes typically requires the programmers to re-write, re-compile, and test the application. The application may require further revision if errors are found in testing which would delay the implementation of the necessary updates to the system. Therefore, the updating of custom software is costly in terms of financial resources and time delays.

Workflow software applications need to be adaptable to business changes and allow users to edit the workflow logic. However, such configurable software applications must overcome several design issues. Applications that enable users to freely write logic statements when editing the workflow logic, allow for opportunities in programming errors to occur that may not be readily apparent to the user and can disrupt the system. Applications that allow users to create or edit workflow logic statements typically require the user to have advanced knowledge in logic programming to use the program editing tools. Software that aims to provide simple user friendly editing tools may limit the logic functions that are provided for use in the workflow logic.

A further issue in the design of user configurable workflow applications is the display of only the workflow logic statements for editing. Users are unable to view the workflow statements in context with the application screens that are presented to workers that execute the workflow processes. Creating and editing the application screens that work in conjunction with the new and/or revised workflow logic are typically performed as a separate task through a separate system tool. The task of co-ordinating necessary application screens to changes in workflow logic through the use of multiple tools and graphical user interfaces is time consuming, inconvenient, and allows for problems and inconsistencies to easily occur that may not be readily apparent to the user.

Integrating new changes to the workflow logic in typical application software requires re-compiling the software and restarting the system. The operability of the system is suspended until it is restarted. This can be a costly interruption to a business, particularly if the new changes require further testing and adjustments that would lead to additional re-compiling and down time.

Prior software that allow the integration of new and revised workflow logic to a system without re-writing and re-compiling the system have required the use of parse trees, which reduces the processing speed and efficiency of the system.

Prior software that allows users to create application screens for a workflow must be designed at the outset to include all necessary screens and fields to meet the needs of every business process. Such screens may be overloaded with fields and information that may not be regularly required for the majority of standard business processes and may confuse and inconvenience workers.

What is needed is a system that utilizes a user friendly graphical user interface tool that allows a user to create and/or edit an application software's workflow logic with minimal opportunities for errors, and efficiently create and/or edit the corresponding workflow application screens without the need to re-write and re-compile the application software, which would otherwise interrupt the operability of the application.

### SUMMARY OF THE INVENTION

The present invention is a graphical user interface (GUI) tool that is used in a workflow management system to allow a user to create and/or edit workflows and simultaneously view, create and/or edit the corresponding application screens that work in conjunction with the workflow logic.

The user friendly design of the GUI tool allows a user to implement the tool without the need for advanced programming knowledge. The GUI tool provides a context sensitive menu of functions, operators, fields, and variables in a user friendly spoken language syntax for users to create and/or edit workflow logic. The GUI tool's context sensitive menu effectively prevents users from making syntactic errors during the process of creating or editing the workflow logic. Therefore, the GUI tool is able to offer users the flexibility of creating and editing workflows while preventing syntactic errors from disrupting the system.

The GUI tool also provides users with the ability to view, create and edit the application screens that work in conjunction with the workflow logic. The application screens are displayed to workers during a business workflow to assist them in performing various business processes. This innovative solution allows users to simultaneously create and configure application screens that function in accordance with the workflow logic as defined by the user.

The system is also designed to integrate any changes to the workflow and the application screens without requiring the re-writing and recompiling of the application program. Users can therefore make changes to the workflow logic and application screens without interrupting the operability of the workflow management system at any time and without causing any downtime.

A graphical user interface program for editing a workflow logic is provided, including a graphical user interface tool displaying, simultaneously: a first screen area wherein an application screen is editable; a second screen area wherein the workflow logic is editable; a third screen area providing a context sensitive menu of a plurality of workflow components presented in a spoken language syntax for use in editing the workflow logic; and a fourth screen area providing a menu of data fields and repeatable fields useable to create a workflow logic statement for said workflow logic.

The workflow logic may be editable by inclusion of data fields added to a database accessible by the graphical user interface tool. The workflow logic may be further editable by replacing the workflow logic statement with a new workflow logic statement. The workflow logic may be further editable to include a plurality of, and arrangement of, data fields and repeatables. The workflow logic may yet be further editable by generation of a new workflow logic statement and inclusion of a previously or newly added field of the database.

The fourth screen area may be dynamically updated to correspond to changes to the fields in the database.

The workflow logic may be further editable by generation of said workflow logic by including an arrangement of operators, functions and fields provided within a context sensitive menu. The workflow logic my be further editable by provision of a construct for applying a while loop. The construct for applying a logic test to all fields may be in a repeatable, and all fields within the repeatable that are one level nested within the repeatable.

The application screen may be editable by modification of the screen to include newly added or modified fields in a database. The application screen may be further editable by replacement of the application screen with a new application screen. The application screen may be further editable to include any number and arrangement of fields and repeatable fields. The application screen may also be editable by generation of a new application screen and addition of a previously added field within a database. The application screen may be further editable by creation of a sub-screen to group the fields and repeatable fields.

A system for dynamically integrating a workflow logic and an application screen associated with the workflow logic, with an application program is provided, the system including an application program for executing the workflow logic and the application screen; a database storing a plurality of fields and a plurality of repeatable fields, and an executable construct corresponding to a business workflow; a graphical user interface tool providing, to a user, a screen area for creation of the workflow logic for the business workflow using: a plurality of defined functions, a plurality of logic operators, a plurality of key-words, and said plurality of fields; to produce an application screen that includes a field and a repeatable field working in conjunction with the workflow logic of the business workflow.

The graphical user interface tool may make available a new or modified field or a new or modified repeatable field as the new or modified field or the new or modified repeatable field is added to the database. The plurality of fields and plurality of repeatable fields may be stored as Extensible Markup Language (XML) code in the database. The graphical user interface tool may provide a menu of context sensitive parameters in a spoken language syntax to create the workflow logic, and may provide means for creating application screens in conjunction with the workflow logic.

The representation of the workflow logic may be presented in a spoken language syntax convertable into XML code that is stored on the database and made available to the application program. Likewise, a representation of the application screen may be converted into XML code that is stored on the database and made available to said application program. Other advantages of the present invention will become apparent from the detailed description of the invention and the illustrations provided herein.

### BRIEF DESCRIPTION OF THE SEVERAL VIEWS OF THE DRAWINGS

FIG. 1 illustrates an exemplary graphical user interface tool according to the invention with its associated component areas;

FIG. 2 illustrates a block diagram of a computing environment in which the present invention may be implemented according to one preferred embodiment;

FIG. 3 is a flow chart of a business workflow;

FIG. 4 is a flow chart of a workflow that shows how each process is represented by an application screen, which effectively provides a one-to-one mapping of the system's workflow logic with respect to the business workflow illustrated in FIG. 3;

FIG. 5 is a screenshot of the GUI tool that illustrates how the tool components are used to configure the application screen and the corresponding workflow logic for the “Verify Info” screen of the system workflow illustrated in FIG. 4;

FIG. 6 is a screenshot of the GUI tool that illustrates how the tool components are used to configure the application screen and the corresponding workflow logic for the “What Type Of Meter” screen of the system workflow illustrated in FIG. 4;

FIG. 7 is a screenshot of the GUI tool that illustrates how the tool components are used to configure the application screen and the corresponding workflow logic for the “Regular Screen” of the system workflow illustrated in FIG. 4;

FIG. 8 is a screenshot of the GUI tool that illustrates how the tool components are used to configure the application screen and the corresponding workflow logic for the “Smart Meter Info” of the system workflow illustrated in FIG. 4;

FIG. 9 is a screenshot of the GUI tool that illustrates how the tool components are used to configure the application screen and the corresponding workflow logic for the “New Meter” screen of the system workflow illustrated in FIG. 4;

FIG. 10 is a screenshot of the GUI tool that illustrates how the tool components are used to configure the application screen and the corresponding workflow logic for the “Complete Screen” of the system workflow illustrated in FIG. 4;

FIG. 11 is a screenshot of the GUI tool that illustrates a context sensitive menu of allowable constructs that are provided when the user selects the “Workflow” statement;

FIG. 12 is a screenshot of the GUI tool that illustrates a context sensitive menu of allowable constructs that are provided when the user selects the “Variable” statement;

FIG. 13 is a screenshot of the GUI tool that illustrates a context sensitive menu of allowable constructs that are provided when the user selects the “Test” function;

FIG. 14 is a screenshot of the GUI tool that illustrates a context sensitive menu of allowable constructs that are provided when the user selects the “Then” function;

FIG. 15 is a screenshot of the GUI tool that illustrates a context sensitive menu of allowable constructs that are provided when the user selects the “Else” function;

FIG. 16 is a screenshot of the GUI tool that illustrates a context sensitive menu of allowable constructs that are provided when the user selects the “While” function;

FIG. 17 is a screenshot of the GUI tool that illustrates the allowable parameters that are provided by the Context Sensitive Editor when the user chooses to configure the “Z” variable within the “Set” construct;

FIG. 18 is a screenshot of the GUI tool that illustrates the allowable parameters that are provided by the Context Sensitive Editor when the user chooses to configure the “Operation” element within the “Set” construct;

FIG. 19 is an example of the workflow programming language;

FIG. 20 is an example of the unique construct for employing a while loop in the workflow logic;

FIG. 21 illustrates an example of the unique construct for incorporating repeatable fields in the workflow logic; and

FIG. 22 is another example of the workflow programming language.

### DETAILED DESCRIPTION OF AN ILLUSTRATIVE EMBODIMENT

The invention and its principles may be produced with many different configurations, forms and design elements. The drawings, illustrations and description of the invention herein are described with the understanding that the present disclosure is to be considered as an exemplification of the principles of the invention and is not intended to limit the invention to the embodiment illustrated. Those skilled in the art will envision many possible variations within the scope of the present invention.

The workflow system includes a graphical user interface (GUI) tool 10 that allows a user to create and/or edit the workflow logic and simultaneously view, create and/or edit the application's workflow screens that work in conjunction with the workflow logic.

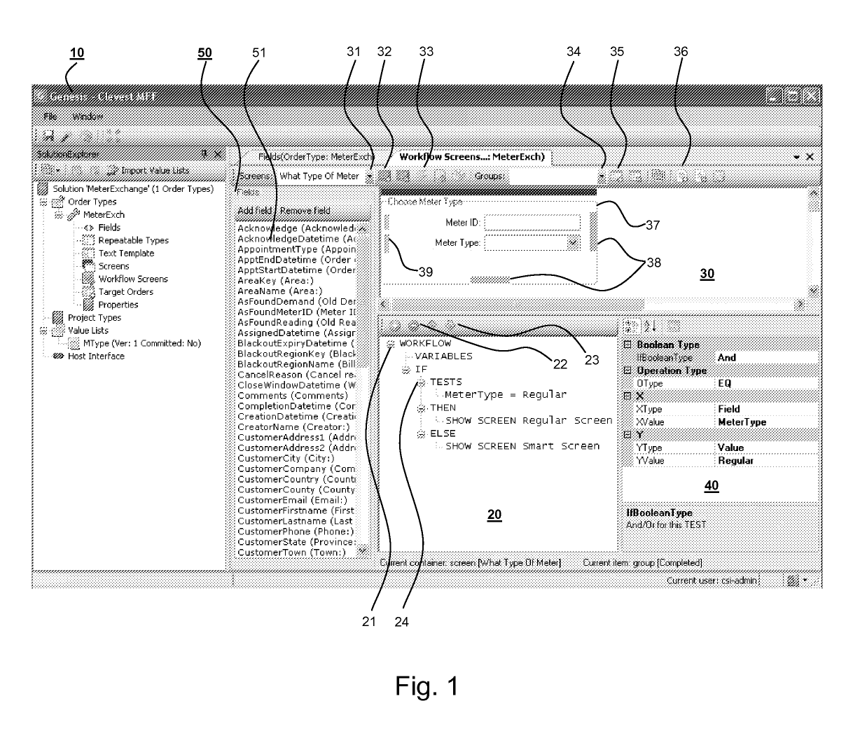

FIG. 1 illustrates the components in a GUI Workflow Screen Tool 10 that is referred to as Genesis. The GUI Workflow Screen tool 10 provides:
a screen area with a Workflow Editor 20 for the user to create and/or edit the workflow logic;
a screen area with a Screen Editor 30 for the user to view, create and/or edit the corresponding workflow screen where the workflow logic is applied in the application;
a screen area with a Context Sensitive Editor 40 that provides a context sensitive menu of allowable parameters to create and/or edit logic statements within the workflow logic; and
a screen area with a Fields Menu 50 that provides data fields and repeatable data fields. Repeatable data fields, also referred to herein as “repeatables” are fields that are a combination of fields that tend to repeat many rows and are also known as tables in an HTML paradigm.

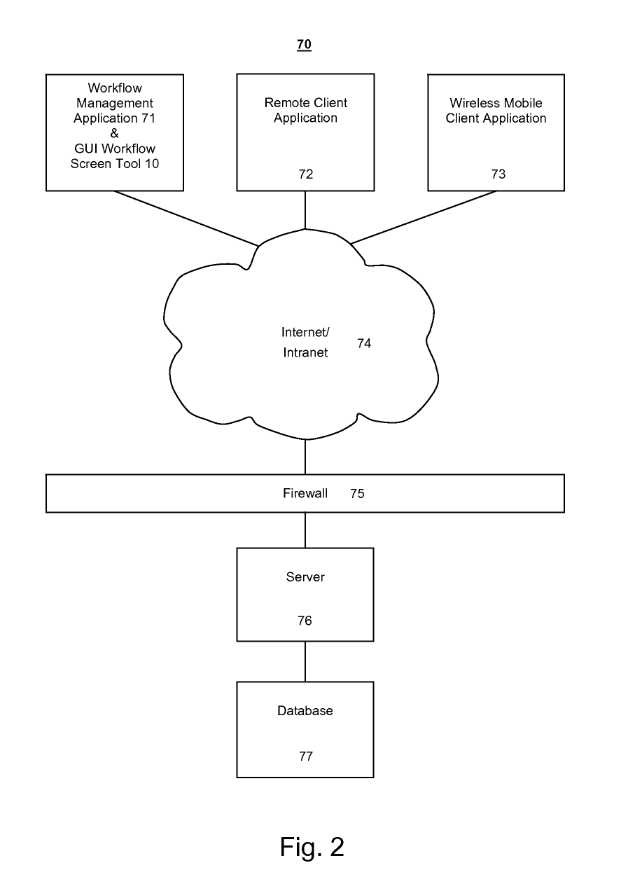

FIG. 2 shows an exemplary computing environment 70 in which the present invention may be implemented. Those skilled in the art will appreciate that the GUI tool 10 may be implemented with other computer system configurations.

The GUI Workflow Screen tool 10 may be implemented in a workflow management application program 71. Remote desktop clients 72 and/or wireless mobile clients 73 may access server 76 and database 77 may access workflow management application program 71 through an intranet or a network 74, such as the Internet. Database 77 is used to store information related to data fields, repeatable fields, workflow logic and application screens. Other components, functions and databases may also be provided.

Once defined, the workflow logic and the application screens may be stored in a database 77 for use by one or more clients 72, 73 when executing workflows.

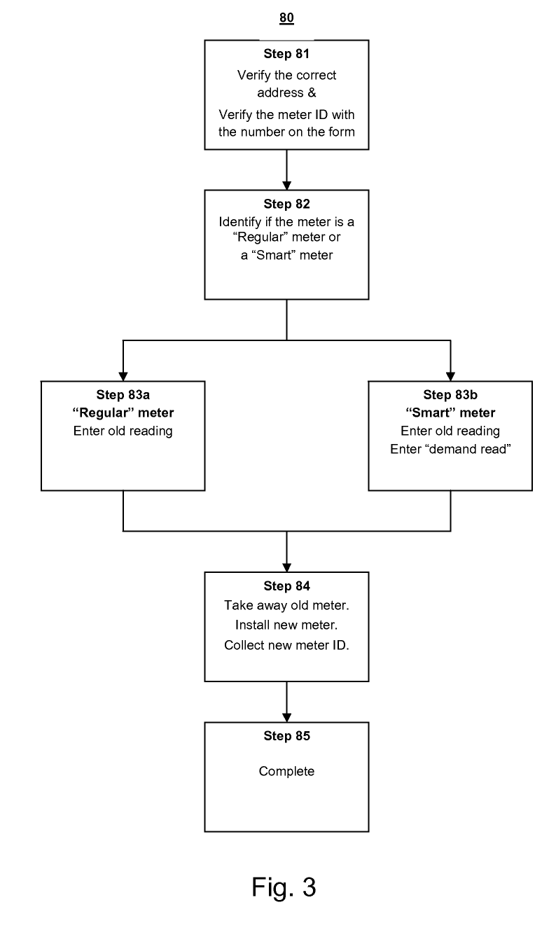

The workflow may be for any sort of business or other activity, and FIG. 3 illustrates an exemplary business workflow 80 for meter replacement work. Workers perform the meter replacement work according to the necessary processes that are defined by the business workflow 80. In Step 81 of workflow 80 workers verify that they have arrived at the correct address and verify the correct meter ID as stated in the work order. In Step 82 the worker identifies if the meter is a “Regular” meter or if the meter is a “Smart” meter. If the meter is a “Regular” meter, the worker performs Step 83a, which requires the entry of an “Old reading”. If the meter is a “Smart” meter, the worker performs Step 83b, which requires the entry of an “Old reading” and the entry of a “Demand read”. The worker then performs Step 84, which requires the removal of the old meter, the installation of a new replacement meter, and the collection of the new meter ID. Step 85 indicates the completion of the workflow.

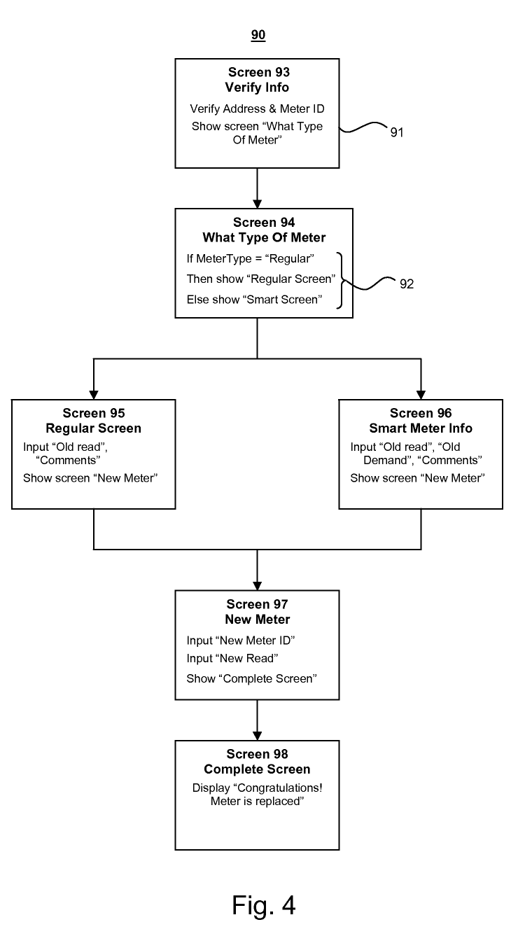

Referring to FIG. 4, application 71 allows the user to create and configure application screens 93 through 98 that are used in a workflow 90 to assist workers in accurately and efficiently executing the necessary processes of business workflow 80 illustrated in FIG. 3.

Each screen 93 through 98 works in conjunction with a user defined workflow logic (such as 91, 92) and is in effect a presentation layer of the workflow logic. The user may create multiple screens that work together to form a complete workflow 90 that models the necessary stages of a business workflow 80. The screens 93 through 98 effectively provide one-to-one mapping and convenient review of the system's workflow logic 90 with respect to the business workflow 80.

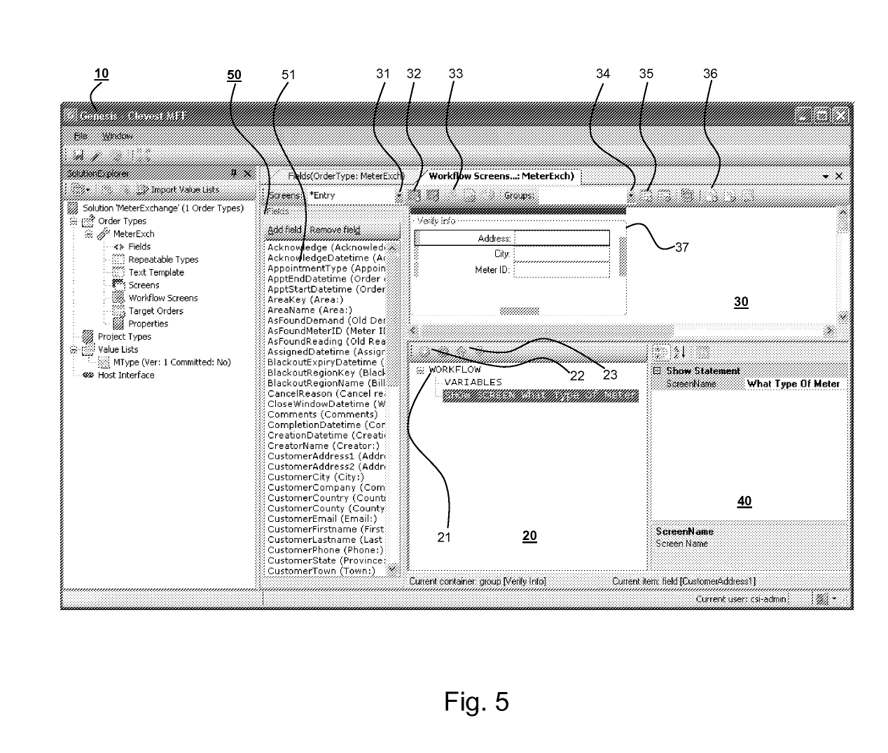

FIG. 5 through FIG. 10 illustrate the configuration of a series of screens that form a complete workflow 90 as illustrated in FIG. 4. Each screen represents an individual process within the business workflow 80 as illustrated in FIG. 3.

FIG. 5 illustrates the use of the GUI tool to configure the workflow screen 37 that is presented on the worker's mobile device, which effectively represents Step 1 of the business workflow 80, and screen 93 within workflow 90. Screen 37 requires workers to enter an address and meter ID to verify that they are at the correct work order location. The GUI tool allows the user to simultaneously view and configure the workflow logic 21 that works in conjunction with the workflow screen 37. The workflow logic 21 is configured to show the “What Type Of Meter” screen 94, which represents step 82 within the business workflow 80, after the worker has entered and verified the address and meter ID.

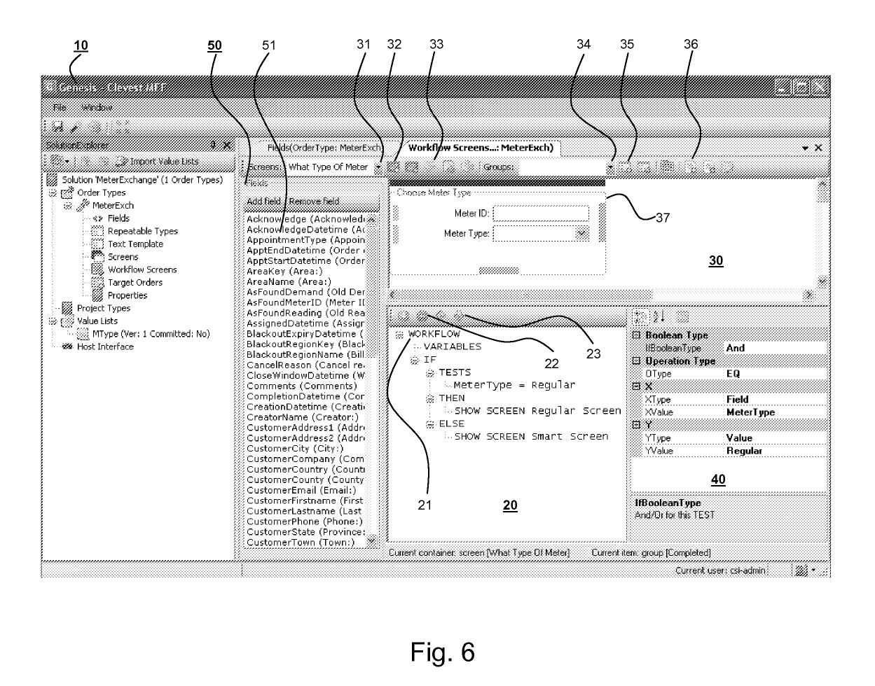

FIG. 6 illustrates the configuration of screen 37 to display the “What Type Of Meter” screen 94, which effectively represents Step 82 of the business workflow 80. Screen 94 requires the worker to enter the meter ID and the meter type. The workflow logic 21 is configured to show the “Regular Screen” if the worker identifies that the meter is a “Regular” meter. Where the meter is identified to be other than a “Regular” meter, the workflow logic 21 is configured to show the “Smart Meter Info” screen.

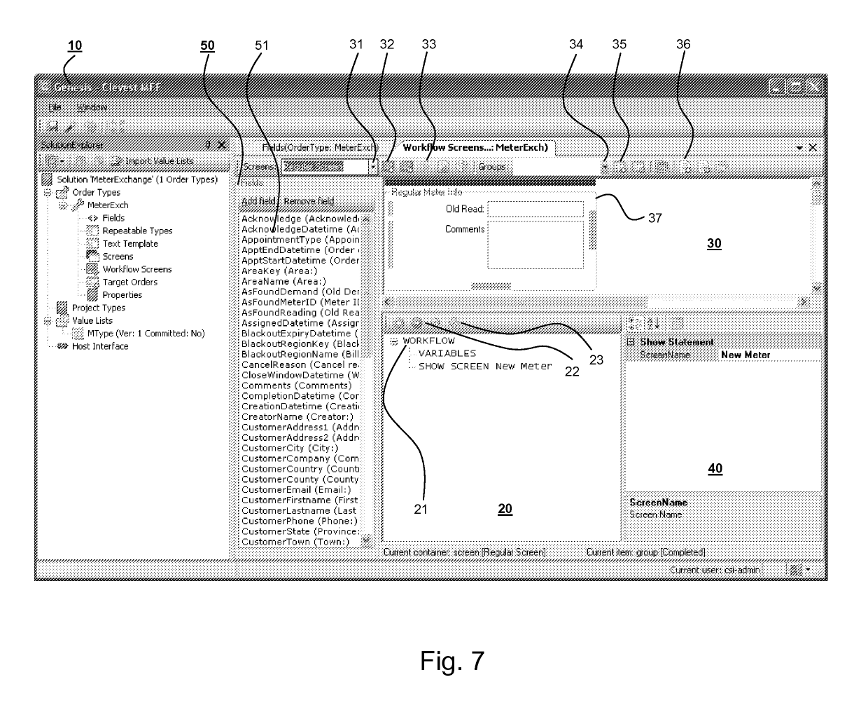

FIG. 7 illustrates the configuration of screen 37 to the “Regular Screen” 95 that represents Step 83a of the business workflow 80. Screen 95 requires the worker to enter a meter reading for the old meter into the “Old Read” field and provides a “Comments” field to allow the entry of applicable comments. The workflow logic 21 is configured to show the “New Meter” screen 97 that represents Step 84 of the business workflow 80 after the worker has completed entering the necessary data.

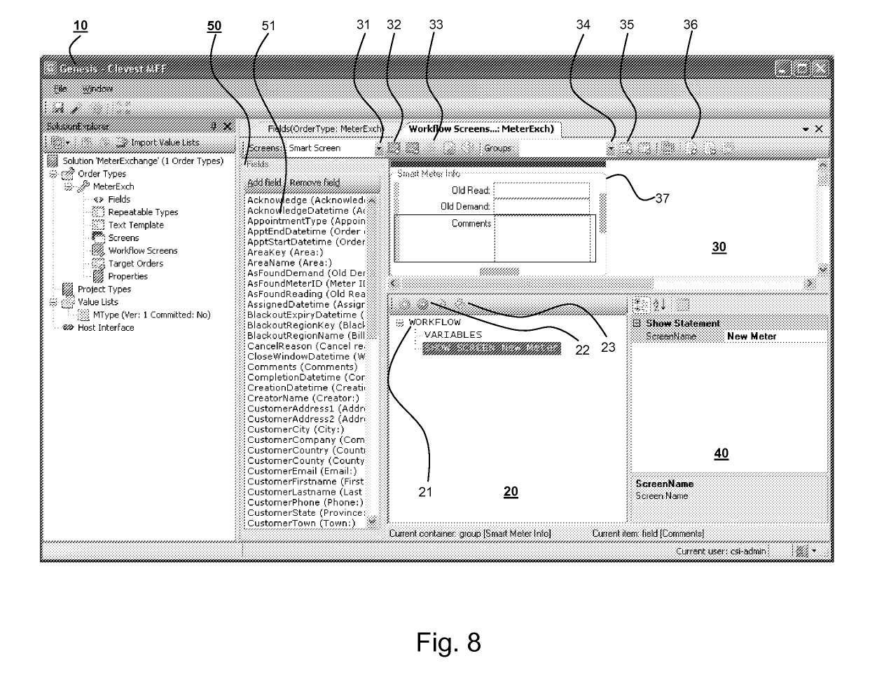

FIG. 8 illustrates the configuration screen 37 to display the “Smart Meter Info” screen 96 that represents Step 83b of the business workflow 80. Screen 96 requires the worker to enter data for the “Old Read” field and the “Old Demand” field, and also provides a “Comments” field to allow the entry of applicable comments. The workflow logic 21 is configured to show the “New Meter” screen 97 that represents Step 84 of the business workflow 80 after the worker has entered all the necessary data.

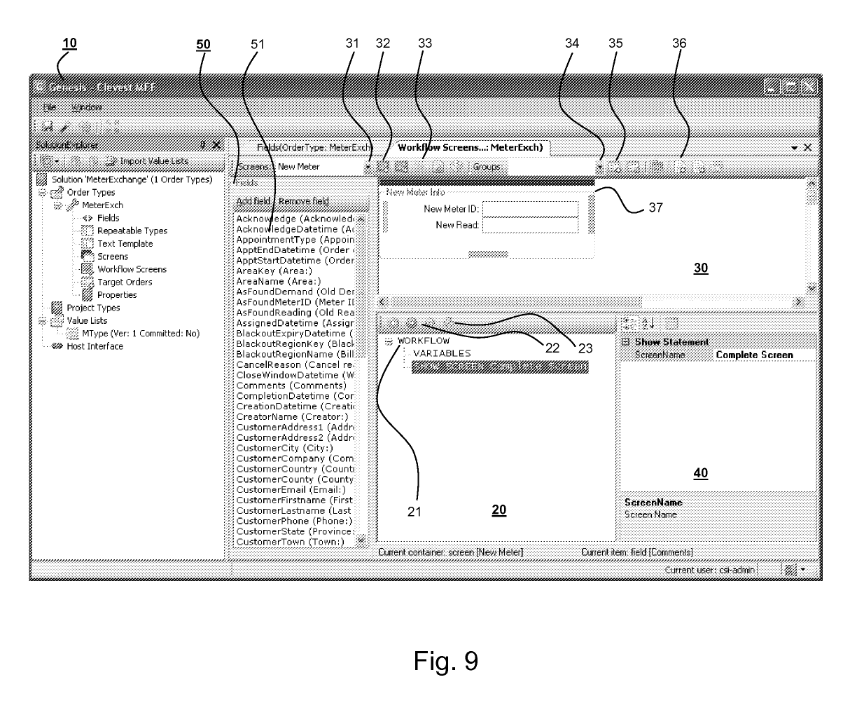

FIG. 9 illustrates the configuration of screen 37 to display the “New Meter” screen 97 that represents Step 84 of the business workflow 80. After the worker has physically replaced the old meter with a new meter, the worker is required to enter the new meter ID and enter a new meter reading in the “New Read” field. The workflow logic 21 is configured to show the “Complete Screen” 98 after the worker has entered the new meter ID and the new meter reading.

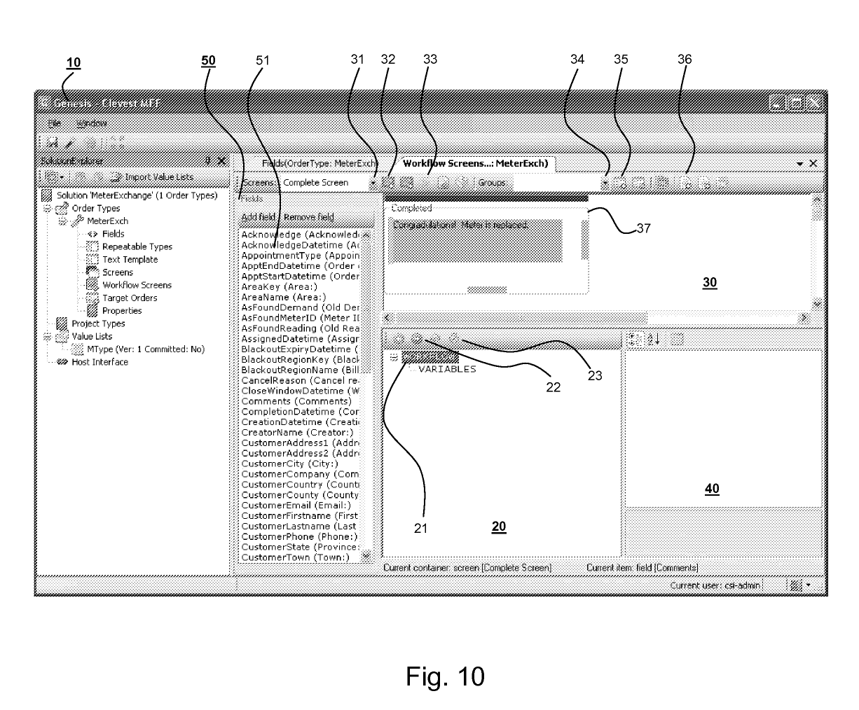

FIG. 10 illustrates the configuration of screen 37 to display the “Completed” screen 98 that represents Step 85 of the business workflow 80. Screen 98 is configured to display a message to inform the worker that the meter replacement work has been successfully completed. The workflow logic 21 shows that subsequent screens are not required, which effectively creates an end point in the workflow.

The GUI tool 10 allows the creation and configuration of screens to gather data from workers to execute the workflow logic. Screens may also be created and configured to display information from the processing of workflow logic and/or request additional data from workers to perform additional workflow logic, or to provide workers with information that is relevant to the immediate task at hand.

Referring to FIG. 1, users may create and configure the screens with screen editor 30. The user may choose to create a new screen using new screen button 32 and define a name for the system, or select a screen listed in the Screen menu for editing using screen drop down menu 31.

The user may set a screen as the start screen using start screen button 33, for a particular workflow 91. The user may configure the screen by adding fields from the Fields Menu 50 and inserting text boxes using the text box button 36 on the toolbar. The fields and text boxes are used to gather data by workers to process the workflow logic as defined by the user. Fields and text boxes are added to the appropriate screen by dragging-and-dropping the fields and repeatables available from Fields menu 50 into screen area 30 or by pointing and clicking with a pointing device, such as a mouse.

Fields menu 50 provides fields and repeatables from a dynamically configurable database 77. New and/or revised fields in database 77 are immediately available to the GUI Workflow-Screen tool 10. The fields have a plurality of properties that can be configured by the user. Examples of field properties include labels, width, height, type orientation, mandatory, read only, and tab order. The system prevents users from deleting fields 51 from database 77 that have been incorporated into the logic flow statements or which have been referenced. All fields and related properties are stored as XML data in database 77.

The user may also configure screens with one or more sub screens 37 referred to as “Groups” to group fields and text boxes together. The grouping of fields provides a convenient means of presenting and positioning fields and text boxes in the screens. Users may configure screens with sub screens by selecting the Group option button 35 from the toolbar to add a sub screen 37. Fields may be directly added to the sub screen 37 areas. The sub screens 37 may be positioned and adjusted in size to accommodate a number of fields by dragging the resize handles 38 that are provided on the sides of the sub screens 37. The fields can be positioned within the screens by dragging the position handles 39 provided at one side (the left side in FIG. 1) of the field. The configured screens are stored in database 77 and made available to the application program 71.

Sub screens 37 that have been added to the screen are listed in a drop down menu that is made available when selecting the drop down menu option 34 from the toolbar. The user may select an individual sub screen listed in the drop down menu 34 for editing or deletion. The sub screens 37 may also be individually selected by clicking a pointing device on an individual sub screen area.

GUI tool 10 provides users the ability to create and configure screens that assist the accurate and efficient execution of business processes within a business workflow 80 by displaying to workers, and/or by retrieving from workers, only the necessary and sufficient information to execute the particular processes in each stage of the business workflow 80. Users of GUI tool 10 have the flexibility to create and configure screens that provide timely information and avoid the display of excessive and irrelevant information that may confuse and inconvenience workers during the execution of business processes.

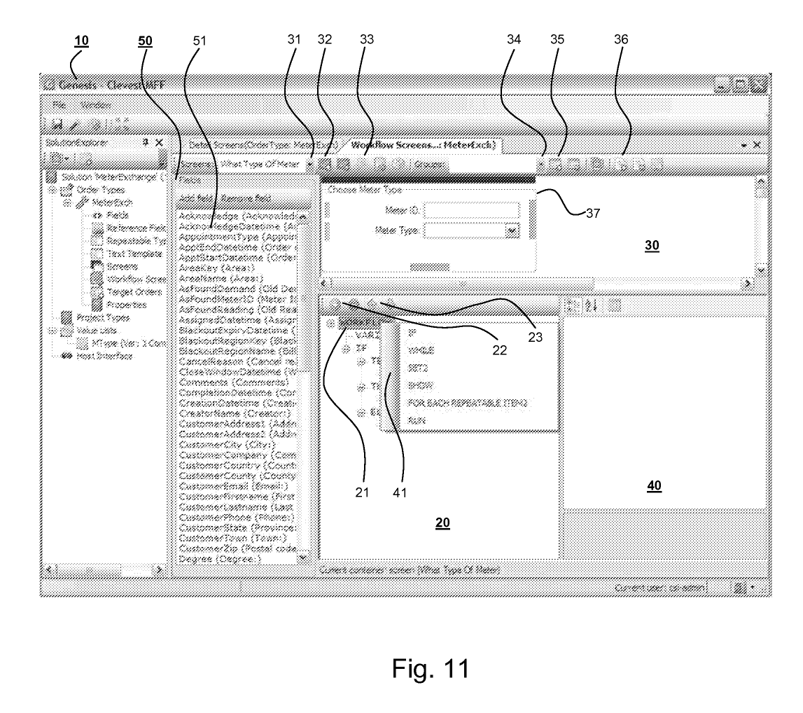

Referring to FIG. 11, Workflow Editor 20 allows users to create new workflow logic and/or edit existing workflow logic that work in conjunction with the application screens. The user may create and/or edit the workflow logic by selecting an element 21 within the workflow logic and then selecting the add option 22 from the toolbar or by right clicking on element 21 with a pointing device. Workflow Editor 20 then provides a context sensitive menu of allowable constructs 41 that the user may use to create and/or edit the workflow logic. The user may only select the options that are provided within the menu of allowable constructs 41. Users are therefore prevented from entering syntactic errors that would disrupt the workflow logic. For example, referring to FIG. 11, when the user selects the “Workflow” element 21 in the Workflow Editor 20, GUI tool 10 provides a menu of allowable constructs 41 that may be used to configure the workflow logic.

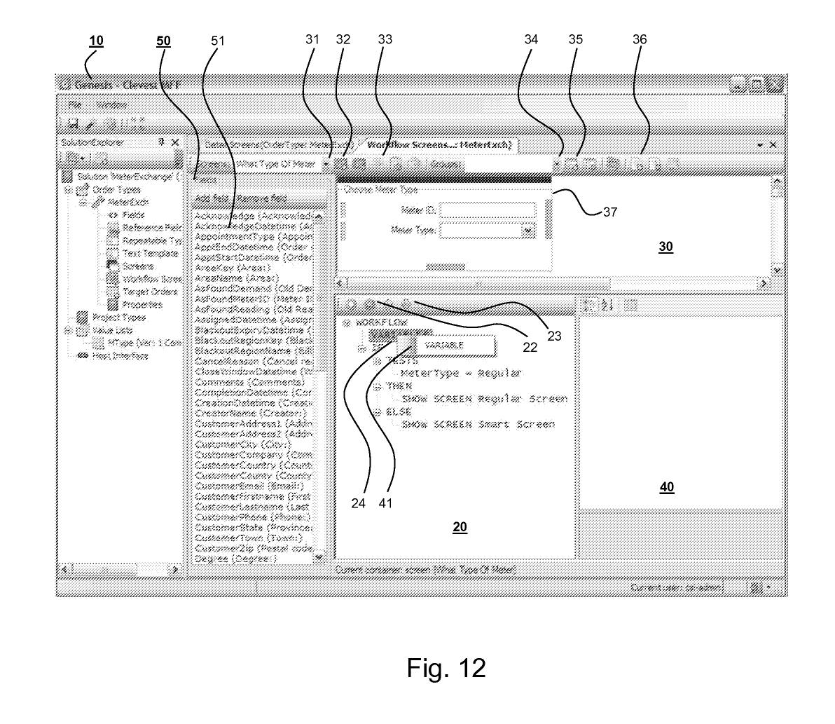

Referring to FIG. 12, when the user selects the “Variable” element 24 within Workflow Editor 20 a context sensitive menu of allowable constructs 41 provides the user with the only allowable “Variable” option to define new variables.

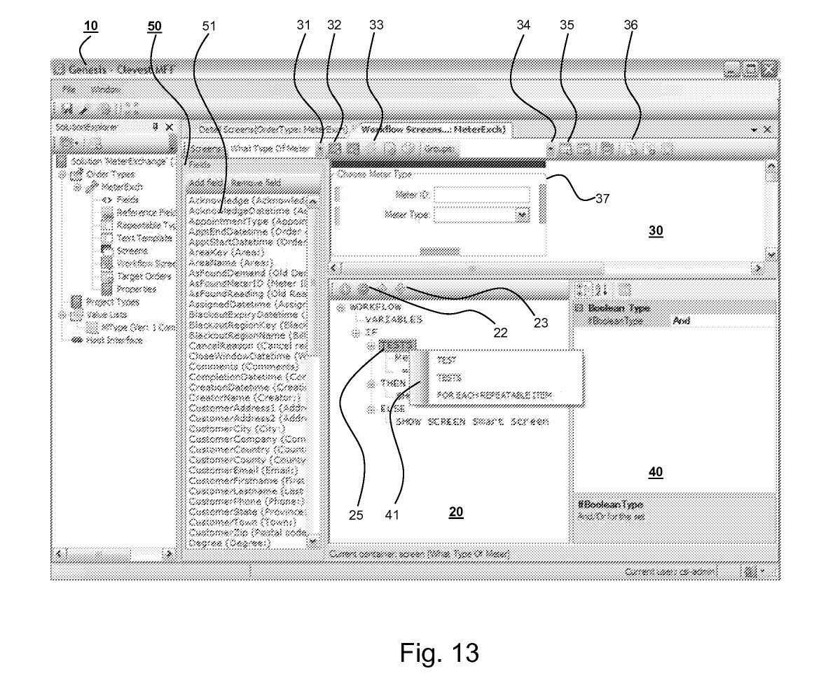

Referring to FIG. 13, when the user selects the “Tests” element 25, Workflow Editor 20 provides a menu of allowable constructs 41 that is specific to the “Tests” element 25, including “Test”, “Tests” and “For Each Repeatable Item”.

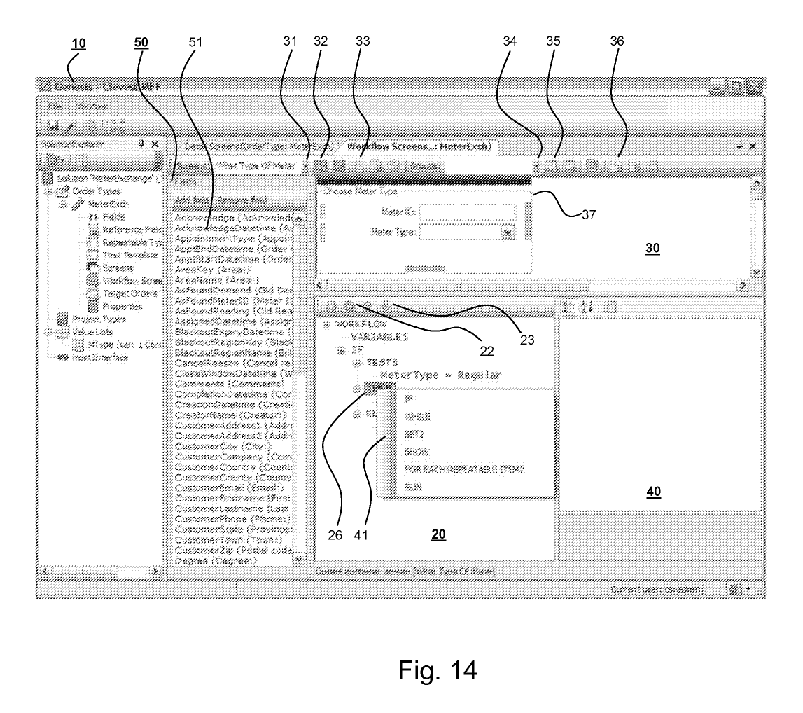

Referring to FIG. 14, when the user selects the “Then” element 26, the Workflow Editor 20 provides a context sensitive menu of allowable constructs 41 for the “Then” element 26, including “If”, “While”, “Set2”, “Show”, “For Each Repeatable Item2” and “Run”.

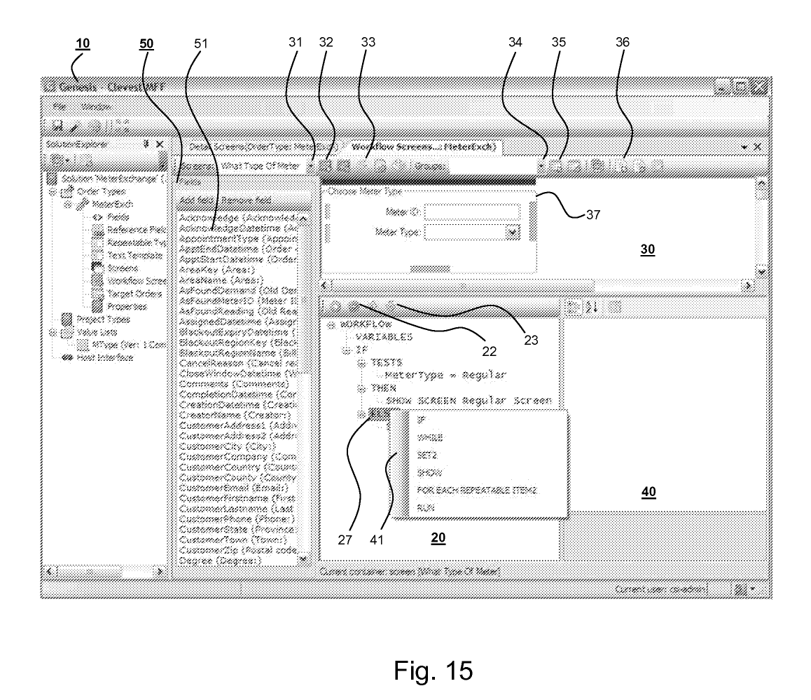

Referring to FIG. 15, when the user selects the “Else” element 27, the Workflow Editor 20 provides a context sensitive menu of allowable constructs 41 for the “Else” element 27, including “If”, “While”, “Set2”, “Show”, “For Each Repeatable Item2” and “Run”.

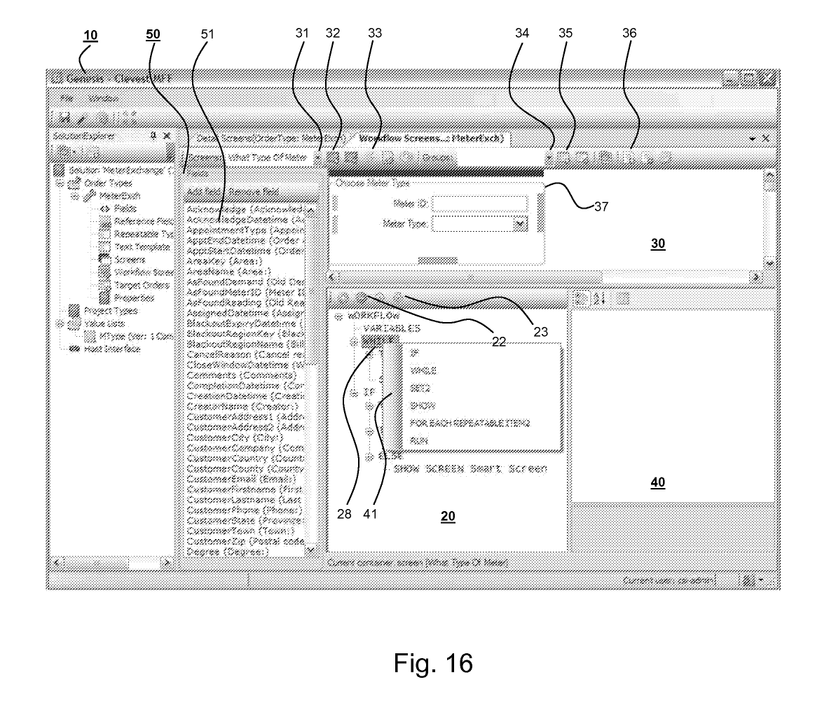

Referring to FIG. 16, when the user selects the “While” element 28, the Workflow Editor 20 provides a context sensitive menu of allowable constructs 41 for the “While” element 28.

When the user selects a construct within the workflow logic from the Workflow Editor 20, the Context Sensitive Editor 40 provides the user with context sensitive allowable parameters for the selected construct. The user may selectively combine the available parameters from the Context Sensitive Editor 40 to configure the workflow logic statements. The Context Sensitive Editor 40 provides the user only with allowable syntactic options to prevent syntactic errors from occurring in the creation or editing of logic statements. The Context Sensitive Editor 40 provides relevant parameters in spoken language syntax for user friendliness.

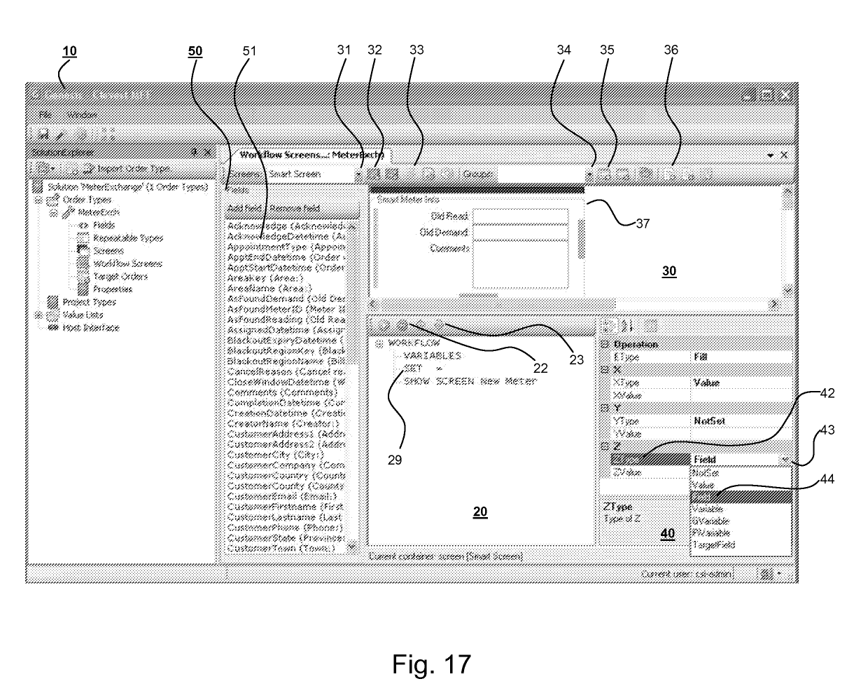

FIG. 17 illustrates parameters that may provided by the Context Sensitive Editor 40 when the user selects the “Set” command 29 within the Workflow Editor 20. The “Set” command 29 represents the following construct:

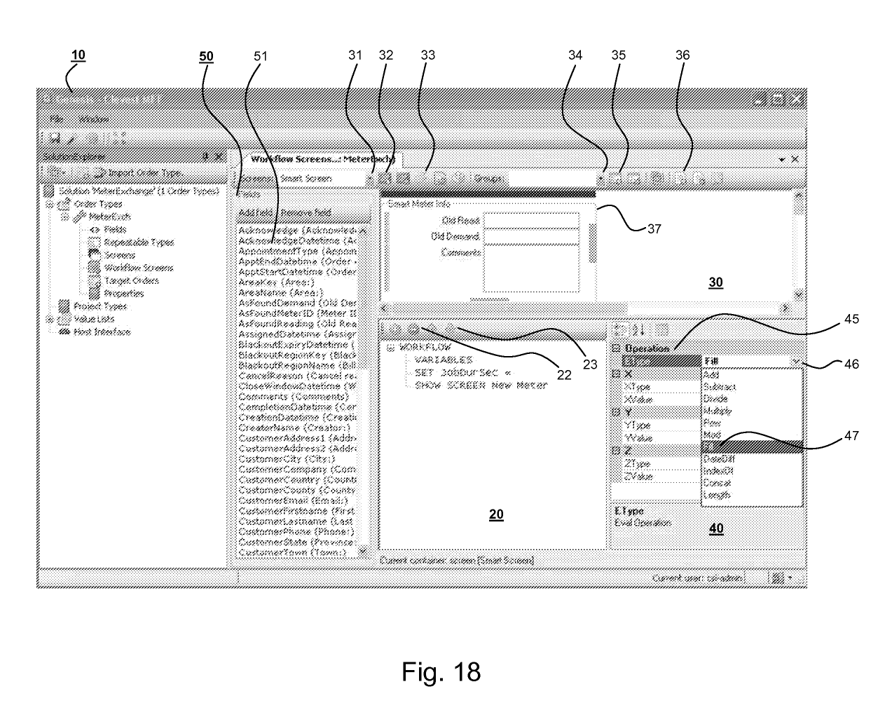

Set Z=X{Operation}Y

wherein the Context Sensitive Editor 40 provides allowable options to configure the “X”, “Y”, and “Z” parameters of the “Set” construct. FIG. 17 illustrates a drop down menu 43 that is provided to the user for configuring the parameter type 42 for the “Z” parameter. The illustration shows as an example that the user has selected the “Field” option 44 from the drop down menu 43 to define the parameter type 42 for the “Z” parameter. FIG. 18 illustrates the allowable options 46 that are provided to the user for configuring the “Operation” element 45 within the construct. The illustration shows as an example that the user has selected the “Fill” option 47 to allow workers to enter a value for the “X” parameter. The examples in FIG. 17 and FIG. 18 illustrate how the Context Sensitive Editor 40 provides the user with only the relevant and syntactically correct options to create and/or edit the workflow logic.

The user may also revise the workflow by re-ordering the sequence of workflow statements through the use of positioning arrows provided in the toolbar 23.

Referring to FIG. 11, the GUI tool 10 allows the user to employ as constructs 41, functions that include “If”, “Tests” “Then”, “Else”, “For each”, “While”, “Show”, and “Run” in the creation of workflow logic constructs to enable complex workflow definitions. Referring to FIG. 20, the system employs construct 101 to provide a while loop for use in the processing of workflow logic.

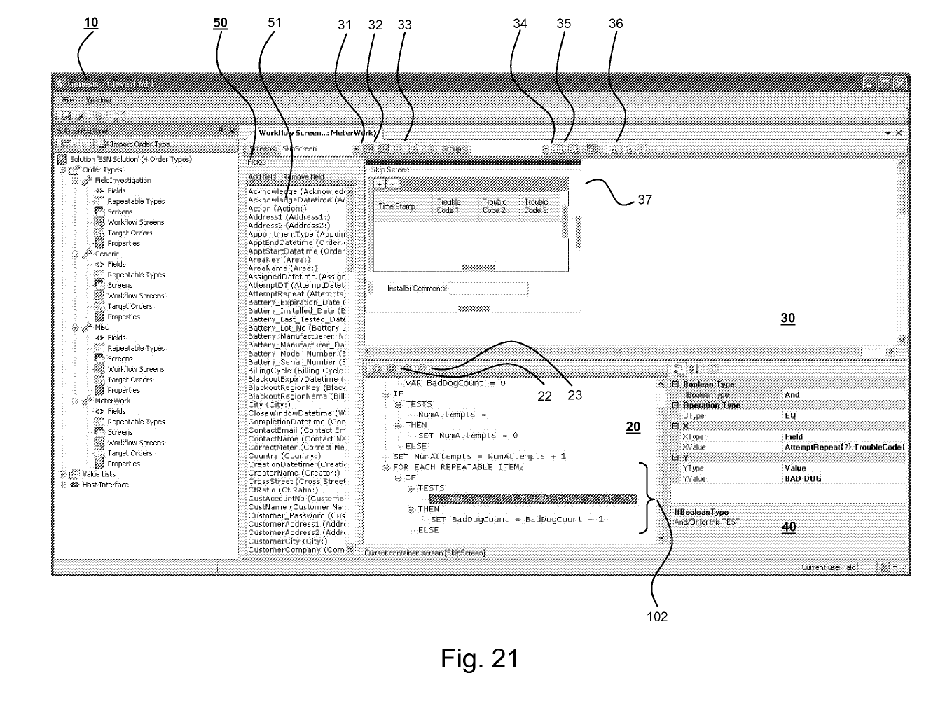

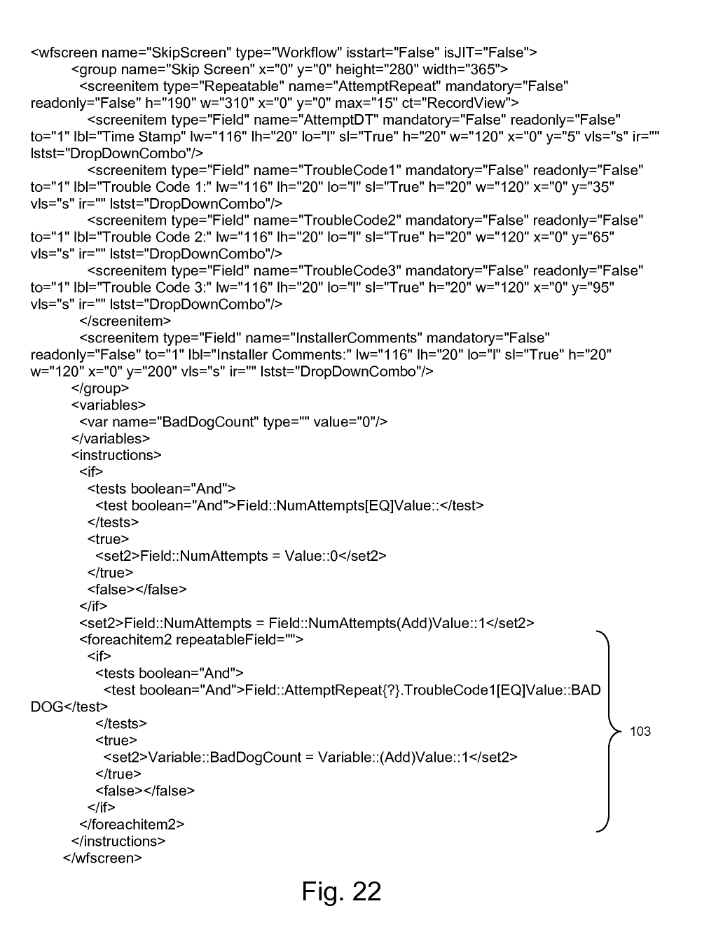

Referring to FIG. 21, the system employs a construct 102 to allow logic tests to be applied to all fields within a repeatable. Repeatable fields may also be nested within a repeatable field and in such instances may be described as “one-level-nested”. The system construct 102 may also be used to apply logic tests to all fields within a repeatable that are one-level-nested within a repeatable field. The construct 102 allows the aggregate analyses of repeatable fields and one-level-nested repeatable fields to be used in the processing of workflow logic. FIG. 22 illustrates the programming language 103 for construct 102 that uses a repeatable in a “Tests” as shown in FIG. 21.

The GUI Workflow-Screen tool 10 integrates the workflow logic as executable constructs that are made available to the application software. The new or edited workflow logic is interpreted by the application software, without requiring the re-writing or re-compiling of the application software and without interrupting the operability of the application software at any time.

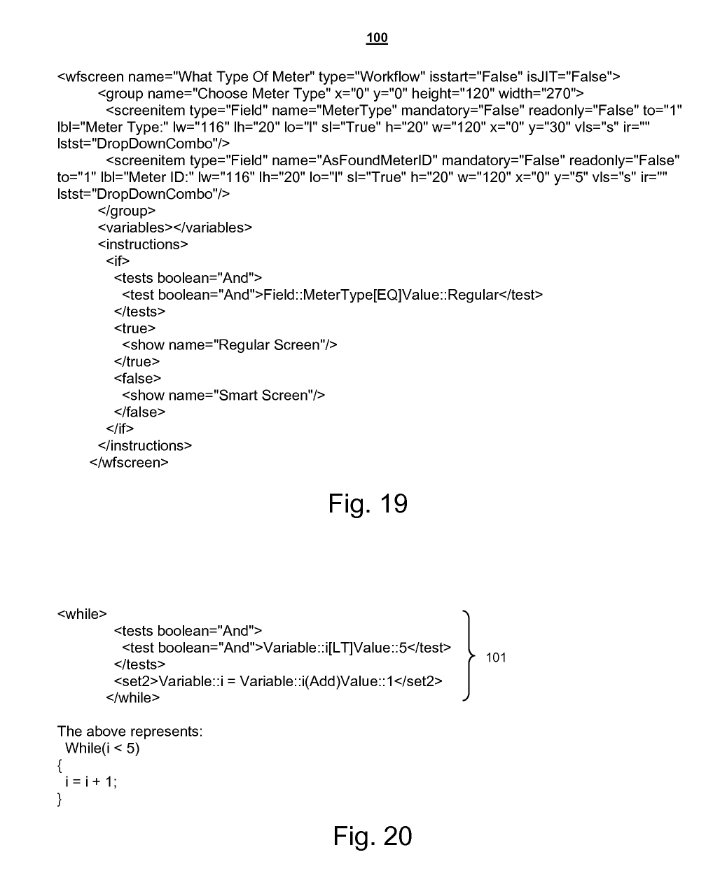

Referring to FIG. 19, the system may integrate workflow logic using programming language based on Extensible Markup Language (XML), which provides programming constructs such as variables, conditions, operations, loops and custom actions and allows users to employ variables and global variables to assist in the logic. The language is loaded as an XML document when the user uploads changes to the database.

The system may use Document Object Model (DOM) methods to traverse the workflow logic. The system uses the DOM to execute the XML instructions as defined by the logic.

A common project is written once and compiled for either desktop, server or PDA consumption. The common project then reads the XML definition for the document and allows the clients 72, 73 to utilize the document and workflow. A client application program de-serializes the XML code into objects that are able to logically evaluate the XML command nodes. The application loads the relevant document files at start up and reloads updated files when notified.

Although the particular preferred embodiments of the invention have been disclosed in detail for illustrative purposes, it will be recognized that variations or modifications of the disclosed apparatus lie within the scope of the present invention.

What is claimed is:

1. A graphical user interface program for editing a workflow logic, comprising:
a graphical user interface tool displaying, simultaneously:
a first screen area wherein an application screen is editable;
a second screen area wherein the workflow logic is editable;
a third screen area providing a context sensitive menu of a plurality of workflow components presented in a spoken language syntax for use in editing the workflow logic; and
a fourth screen area providing a menu of data fields and repeatable fields useable to create a workflow logic statement for said workflow logic.

2. The graphical user interface of claim 1 wherein said workflow logic is editable by inclusion of data fields added to a database accessible by the graphical user interface tool.

3. The graphical user interface of claim 2 wherein said workflow logic is further editable by replacing said workflow logic statement with a new workflow logic statement.

4. The graphical user interface of claim 1 wherein the workflow logic is further editable to include a plurality of, and arrangement of, said data fields and repeatables.

5. The graphical user interface of claim 1 wherein the workflow logic is further editable by generation of a new workflow logic statement and inclusion of a previously or newly added field of a database.

6. The graphical user interface of claim 5 wherein said fourth screen area is dynamically updated to correspond to changes to said fields in said database.

7. The graphical user interface of claim 1 wherein said workflow logic is further editable by generation of said workflow logic including an arrangement of operators, functions and fields provided within a context sensitive menu.

8. The graphical user interface of claim 7 wherein said workflow logic is further editable by provision of a construct for applying a while loop.

9. The graphical user interface of claim 7 wherein a construct is provided for applying logic tests to all fields in a repeatable, and all fields within said repeatable that are one level nested within said repeatable.

10. The graphical user interface of claim 1 wherein said application screen is further editable by modification of said screen to include newly added or modified fields in a database.

11. The graphical user interface of claim 1 wherein said application screen is further editable by replacement of said application screen with a new application screen.

12. The graphical user interface of claim 1 wherein the application screen may be editable to include any number and arrangement of fields and repeatable fields.

13. The graphical user interface of claim 1 wherein the application screen is further editable by generation of a new application screens and addition of a previously added field within a database.

14. The graphical user interface of claim 1 wherein the application screen is further editable by creation of a sub-screen to group said fields and repeatable fields.

15. A system for dynamically integrating a workflow logic and an application screen associated with the workflow logic, with an application program, the system comprising:
an application program for executing the workflow logic and the application screen;
a database storing a plurality of fields and a plurality of repeatable fields, and an executable construct corresponding to a business workflow;
a graphical user interface tool providing, to a user, a screen area for creation of said workflow logic for said business workflow using:
a plurality of defined functions,
a plurality of logic operators,
a plurality of key-words,
said plurality of fields;
to produce an application screen that includes a field and a repeatable field working in conjunction with said workflow logic of said business workflow.

16. The system of claim 15 wherein said graphical user interface tool makes available a new or modified field or a new or modified repeatable field as said new or modified field or said new or modified repeatable field is added to said database.

17. The system of claim 16 wherein said plurality of fields and plurality of repeatable fields are stored as Extensible Markup Language (XML) code in said database.

18. The system of claim 15 wherein said graphical user interface tool provides a menu of context sensitive parameters in a spoken language syntax to create said workflow logic.

19. The system of claim 15 wherein said graphical user interface tool provides means for creating application screens in conjunction with said workflow logic.

20. The system of claim 15 wherein a representation of said workflow logic is presented in a spoken language syntax convertable into XML code that is stored on said database and made available to said application program.

21. The system of claim 15 wherein a representation of said application screen is converted into XML code that is stored on said database and made available to said application program.
